(19) United States
(12) Patent Application Publication
(10) Pub. No.: US 2017/0360236 A1
(43) Pub. Date: Dec. 21, 2017

(54) CLIP WITH A RUBBER LINING FOR THE PURPOSE OF HOLDING CURTAINS

(71) Applicants: Frank Alan Walters, Johnsonville, NY (US); Lindsey Walters, Johnsonville, NY (US)

(72) Inventors: Frank Alan Walters, Johnsonville, NY (US); Lindsey Walters, Johnsonville, NY (US)

(21) Appl. No.: 15/620,825

(22) Filed: Jun. 13, 2017

Related U.S. Application Data
(60) Provisional application No. 62/351,158, filed on Jun. 16, 2016.

(51) Int. Cl. A47H 5/08; A47H 23/00; E06B 9/78

(52) U.S. Cl. CPC A47H 5/08; E06B 2009/785; A47H 2023/003; E06B 9/78

(57) ABSTRACT

A curtain clip that can be used to hold bunched up curtains to the side, and does not slide vertically because a rubber lining affixed along the inside edge prevents the curtain clip from sliding vertically. The rubber lining prevents the curtain clip from sliding on sheer curtains and other curtains that have a somewhat slippery surface texture. The curtain clip also eliminates ropes and tie backs that would otherwise have to be permanently affixed to the window frame or wall using screws or other fastening devices

### BACKGROUND

The problem this invention addresses is that there are no products on the market that successfully and easily hold curtains to the side. The ropes and tie backs get in the way and are cumbersome to tie and arrange. Furthermore, the ropes and tie backs must be permanently affixed to the window frame or wall using screws or other fastening devices. This leaves holes or adhesive stuck to the frame or wall.

There are some existing clips, however they slide off or have an incredibly complicated design, preventing their easy or successful use.

### SUMMARY OF THE INVENTION

The present invention solves these issues by utilizing a design inspired from hair clips, and by adding a rubber lining to the inside of the clip. The present invention uses clips that are larger than hair clips, but similar in mechanical function. The rubber lining prevents the clip from sliding on sheer curtains and other curtains that have a somewhat slippery surface texture. The clip is manually operable.

### BRIEF DESCRIPTION OF THE DRAWINGS

FIG. 1 illustrates a system including one embodiment of a pair of clips holding curtains to the side and not slipping because of the rubber lining inside the clips.

FIG. 2 illustrates a system including one embodiment of the clip with rubber lining for the purpose of holding curtains.

FIG. 3 illustrates a system including one embodiment of the clip with rubber lining for the purpose of holding curtains.

FIG. 4 illustrates a system including one embodiment of the clip with rubber lining for the purpose of holding curtains.

### DETAILED DESCRIPTION

The present invention uses clips that are larger than hair clips, but similar in mechanical function. Another difference is the present invention has a clip with a rubber lining along the inside edge. The rubber lining prevents the clip from sliding vertically on sheer curtains and other curtains that have a somewhat slippery surface texture.

The body of the clip may be made of plastic, wood or other stable easily accessible materials.

The clip binds curtains vertically, so that the clips close on the left and right side of bunched up curtains. The clip wraps around the bunched up curtains.

The clips would function in pairs, so that 1 clip holds the left side's bunched up curtains, and another clip holds the right side's bunched up curtains.

The clip is operable manually, and includes 2 solid pieces and a lever portion, such that each piece has a smaller straight part above the lever portion and a larger curved part below the lever portion. The lever portion is what connects the 2 solid pieces, and when the smaller straight parts of each piece are squeezed together, the two bottom curved parts below the lever portion open up, so that the bottom curved parts can be placed around bunched up curtains.

One embodiment of the clip would be 3 inches in width and 6 inches in length. This seems to be the ideal size in order to successfully hold average size curtains in an average house. The ratio of length to width is 2 to 1. There is a range of possible lengths and widths that also work well, the length can be between 4 and 8 inches, and the width can be between 2 and 4 inches.

The rubber lining goes around the entire edge of the inside of the clip. The ideal width of the rubber lining is one-third of an inch. This can vary but maintain the ratio to the length of the clip. This ratio is 1/9, so that the width of the rubber lining is 1/9 the size of the length of the clip.

The rubber lining can be affixed to the clip by any reasonable method, such as by gluing it on.

The clip has an optional decorative design element on the outside that might add to the visual appeal of the curtains. One embodiment of this is a plastic clip, in which the larger curved sides of each curtain retainer member has 4 cutouts, and on the opposite side of the lever portion, the smaller straight part of each curtain retainer member has 5 ornamental slots.

Another embodiment is a plastic clip, in which the larger curved sides of each clip retainer member has 4 ornamental extensions, and on the opposite side of the lever portion, the smaller straight part of each clip retainer member has 5 ornamental extensions.

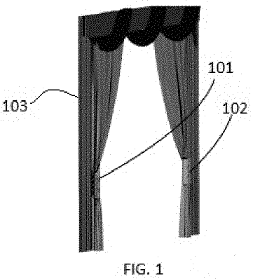

FIG. 1

FIG. 1 illustrates a system including one embodiment of a pair of clips holding curtains to the side and not slipping because of the rubber lining inside the clips. FIG. 1 includes a system with multiple parts: a clip 101, a clip 102, and curtains 103. Clips 101 and 102 hold the sides of the bunched up curtains 103 so that the bunched up curtains stay to the side. Clips 101 and 102 stay at their vertical position and do not slide down the curtains 103 even though the curtains 103 might be sheer or otherwise made of a slippery texture, because the rubber lining on the inside of each clip 101 and 102 holds them in place.

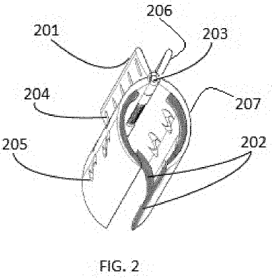

FIG. 2

FIG. 2 illustrates a system including one embodiment with multiple parts: a clip 201, a rubber lining 202, a lever portion 203, ornamental extensions 204, and different ornamental extensions 205. FIG. 2 provides a 3-dimensional view of the clip.

The lever portion 203 includes a spring hinge to allow the clip to open and close.

The lever portion 203 allows the clip to expand and contract, which allows the clip to wrap around the bunched up curtains. The rubber lining 202 helps the clip to maintain its vertical position on the curtains. The ornamental extensions 204 and 205 are decorative and extend less than 1/3 of an inch.

Parts 206 and 207 are the same solid piece of wood, where 206 is straight and above the lever portion, while 207 is curved and larger than 206. The corresponding parts on the other side of the clip are also 1 solid piece of wood.

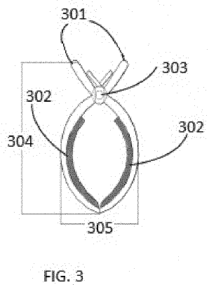

FIG. 3 illustrates a system including one embodiment with multiple parts: a clip 301, a rubber lining 302, a lever portion 303. In this embodiment, the height 304 of the clip is 3 inches, and the width 305 of the clip while closed is 2 inches. The lever portion 303 includes a spring hinge to allow the clip to open and close. FIG. 3 provides a 2-dimensional view of the clip.

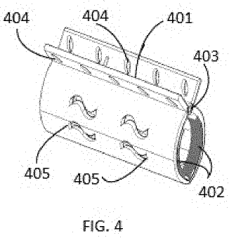

FIG. 4

FIG. 4 illustrates a system including one embodiment with multiple parts: a clip 401, a rubber lining 402, a lever portion 403, ornamental extensions 404, and different ornamental extensions 405. FIG. 4 provides a 3-dimensional view of the clip.

The lever portion 403 includes a spring hinge to allow the clip to open and close. The lever portion 403 allows the clip to expand and contract, which allows the clip to wrap around the bunched up curtains. The rubber lining 402 helps the clip to maintain its vertical position on the curtains. The ornamental slots 404 and 405 are decorative and extend less than 1/3 of an inch.

The clip 401 includes a pair of clip retainer members having an elongated longitudinal side. There is a rubber lining 402 affixed to the inside of the clip around the edge of both halves of the clip.

On each of the clip retainer members there are 4 ornamental slots 405 on the larger curved sides of each clip retainer member. Each curtain retainer member also has 5 ornamental slots 404 on the smaller straight part of each curtain retainer member, on the opposite side of the lever portion 403 from the ornamental slots 405. This will allow the clip retainer members to clamp down on the bunched up curtains easily.

What is claimed is:

1. A clip for holding curtains to the side, comprising:
a clip with a rubber lining along the inside edge that provides an adhesive quality for maintaining the proper vertical position in order to hold a set of bunched up curtains.

2. The clip of claim 1, further comprising:
the clip has a length to width ratio of 2 to 1, the length is between 4 and 8 inches, and the width is between 2 and 4 inches;
the width of the rubber lining is 1/9 the size of the length of the clip.
